(19) United States
(12) Patent Application Publication
(10) Pub. No.: US 2015/0089453 A1
(43) Pub. Date: Mar. 26, 2015

(54) Systems and Methods for Interacting with a Projected User Interface

(71) Applicant: Aquifi, Inc., Palo Alto, CA (US)

(72) Inventors: Carlo Dal Mutto, Sunnyvale, CA (US); Abbas Rafii, Palo Alto, CA (US); Britta Hummel, Berkeley, CA (US)

(73) Assignee: Aquifi, Inc.

(21) Appl. No.: 14/497,090

(22) Filed: Sep. 25, 2014

Related U.S. Application Data
(60) Provisional application No. 62/009,844, filed on Jun. 9, 2014.
(60) Provisional application No. 61/960,783, filed on Sep. 25, 2013.

(51) Int. Cl. G06F 3/0481; G06F 3/01; G06F 3/0484

(52) U.S. Cl. CPC G06F 3/04815; G06F 3/04842; G06F 3/017
USPC 715/852

(57) ABSTRACT

A system and method for providing a 3D gesture based interaction system for a projected 3D user interface is disclosed. A user interface display is projected onto a user surface. Image data of the user interface display and an interaction medium are captured. The image data includes visible light data and IR data. The visible light data is used to register the user interface display on the projected surface with the Field of View (FOV) of at least one camera capturing the image data. The IR data is used to determine gesture recognition information for the interaction medium. The registration information and gesture recognition information is then used to identify interactions.

### CROSS-REFERENCE TO RELATED APPLICATIONS

The current application claims priority under 35 U.S.C. §119(e) to U.S. Provisional Patent Application No. 62/009,844, entitled “Systems and Methods for Interacting with a Projected User Interface”, filed Jun. 9, 2014 and U.S. Provisional Patent Application No. 61/960,783, entitled “Interaction with Projected Imagery Systems and Methods”, filed Sep. 25, 2013. The disclosures of these applications are hereby incorporated by reference as if set forth herewith.

### FIELD OF THE INVENTION

This invention relates to projected Three Dimensional (3D) user interface systems. More specifically, this invention relates to interacting with the projected 3D user interface using gestures.

### BACKGROUND OF THE INVENTION

Operating systems can be found on almost any device that contains a computing system from cellular phones and video game consoles to supercomputers and web servers. A device's operating system (OS) is a collection of software that manages computer hardware resources and provides common services for user application programs. The OS typically acts as an interface between the hardware and the programs requesting input or output (I/O), CPU resources, and memory allocation. When an application executes on a computer system with an operating system, the application's code is usually executed directly by the hardware and can make system calls to the OS or be interrupted by it. The portion of the OS code that interacts directly with the computer hardware and implements services for applications is typically referred to as the kernel of the OS. The portion that interfaces with the applications and users is known as the shell. The user can interact with the shell using a variety of techniques including (but not limited to) using a command line interface or a graphical user interface (GUI).

Most modern computing devices support graphical user interfaces (GUI). GUIs are typically rendered using one or more interface objects. Actions in a GUI are usually performed through direct manipulation of graphical elements such as icons. In order to facilitate interaction, the GUI can incorporate one or more interface objects referred to as interaction elements that are visual indicators of user action or intent (such as a pointer), or affordances showing places where the user may interact. The term affordance here is used to refer to the fact that the interaction element suggests actions that can be performed by the user within the GUI.

A GUI typically uses a series of interface objects to represent in a consistent manner the ways in which a user can manipulate the information presented to the user via the user interface. In the context of traditional personal computers employing a keyboard and a pointing device, the most common combination of such objects in GUIs is the Window, Icon, Menu, Pointing Device (WIMP) paradigm. The WIMP style of interaction uses a virtual input device to control the position of a pointer, most often a mouse, trackball and/or trackpad and presents information organized in windows and/or tabs and represented with icons. Available commands are listed in menus, and actions can be performed by making gestures with the pointing device.

The term user experience is generally used to describe a person's emotions about using a product, system or service. With respect to user interface design, the ease with which a user can interact with the user interface is a significant component of the user experience of a user interacting with a system that incorporates the user interface. A user interface in which task completion is difficult due to an inability to accurately convey input to the user interface can lead to negative user experience, as can a user interface that rapidly leads to fatigue.

Touch interfaces, such as touch screen displays and trackpads, enable users to interact with GUIs via two dimensional (2D) gestures (i.e. gestures that contact the touch interface). The ability of the user to directly touch an interface object displayed on a touch screen can obviate the need to display a cursor. In addition, the limited screen size of most mobile devices has created a preference for applications that occupy the entire screen instead of being contained within windows. As such, most mobile devices that incorporate touch screen displays do not implement WIMP interfaces. Instead, mobile devices utilize GUIs that incorporate icons and menus and that rely heavily upon a touch screen user interface to enable users to identify the icons and menus with which they are interacting.

Multi-touch GUIs are capable of receiving and utilizing multiple temporally overlapping touch inputs from multiple fingers, styluses, and/or other such manipulators (as opposed to inputs from a single touch, single mouse, etc.). The use of a multi-touch GUI may enable the utilization of a broader range of touch-based inputs than a single-touch input device that cannot detect or interpret multiple temporally overlapping touches. Multi-touch inputs can be obtained in a variety of different ways including (but not limited to) via touch screen displays and/or via trackpads (pointing device).

In many GUIs, scrolling and zooming interactions are performed by interacting with interface objects that permit scrolling and zooming actions. Interface objects can be nested together such that one interface object (often referred to as the parent) contains a second interface object (referred to as the child). The behavior that is permitted when a user touches an interface object or points to the interface object is typically determined by the interface object and the requested behavior is typically performed on the nearest ancestor object that is capable of the behavior, unless an intermediate ancestor object specifies that the behavior is not permitted. The zooming and/or scrolling behavior of nested interface objects can also be chained. When a parent interface object is chained to a child interface object, the parent interface object will continue zooming or scrolling when a child interface object's zooming or scrolling limit is reached.

The evolution of 2D touch interactions has led to the emergence of 3D user interfaces that are capable of 3D interactions. A variety of machine vision techniques have been developed to perform three dimensional (3D) gesture detection using image data captured by one or more digital cameras (RGB and/or IR), or one or more 3D sensors such as time-of-flight cameras, structured light systems and single cameras/multi cameras active and passive systems. Detected gestures can be static (i.e. a user placing her or his hand in a specific pose) or dynamic (i.e. a user transition her or his hand through a prescribed sequence of poses). Based upon changes in the pose of the human hand and/or changes in the pose of a part of the human hand over time, the image processing system can detect dynamic gestures.

One particular process where 3D interactions are useful is in the provision 2D touch interactions with a projected GUI. In this type of system, 2D touch interactions with the display are captured using 3D gesture detection methods. This allows a user to emulate the touch interaction of touch screen on the projected display.

### SUMMARY OF THE INVENTION

The above and other problems are solved and an advance in the art is made by systems and methods for interacting with a projected user interface in accordance with embodiments of this invention. In accordance with some embodiments of this invention, 3D interaction system generates a user interface display including interactive objects. The user interface display is projected onto a projection surface using a projector. At least one image capture device captures image data of the projected user interface display on the projection surface. Visible light image data is obtained from the image data and is used to generate registration information that registers the user interface display on the projected surface with the field of view of the at least one image capture devices providing the image data. IR image data from the image data is obtained and used to generate gesture information for an interaction medium in the image data. An interaction with an interactive object with the user interface display is identified using the gesture information and the registration information.

In accordance with some embodiments, the generating of the registration information includes determining geometric relationship information that relates the FOV of the at least one camera to the user interface display on the projection surface. In accordance with many of embodiments, the geometric relationship is the homography between the FOV of the at least one camera and the user interface display on the projection surface. In a number of embodiments, the geometric relationship information is determined based upon AR tags in the projected user interface display. In accordance with several embodiments, the projected user interface display includes at least four AR tags. In some particular embodiments, the AR tags are interactive objects in the user interface display.

In accordance with some embodiments, the generating of the registration information includes determining 3D location information for the projection surface indicating a location of the projection surface in 3D space. In accordance with many embodiments, the 3D location information is determined based upon fiducials within the user interface display. In accordance with a number of embodiments, the user interface display includes at least 3 fiducials. In accordance with several embodiments, each fiducial in the user interface display is an interactive object in the user interface display.

In accordance with some embodiments, at least one IR emitter emits IR light towards the projected surface to illuminate the interaction medium.

In accordance with some embodiments, the visible light image data is obtained from images captured by the at least one camera that include only the projected user interface display on the projection surface.

In accordance with many embodiments, the visible light image data is obtained from images captured by the at least one camera that include the interaction medium and the projected user interface display on the projection surface.

In accordance with some embodiments, the IR image data is obtained from images captured by the at least one camera that include the interaction medium and the projected user interface display on the projection surface and the interaction medium.

In accordance with some embodiments, the image data is captured using at least one depth camera.

### BRIEF DESCRIPTION OF THE DRAWINGS

FIG. 1 illustrates a high level block diagram of a system configured to provide a projected 3D user interface in accordance with embodiments of this invention.

FIG. 2 illustrates a high level block diagram of a processing system providing a projected 3D user interface in accordance with embodiments of this invention.

FIG. 3 illustrates a conceptual diagram of a projected user interface display and Field of View (FOV) of one or more image capture devices in accordance with an embodiment of this invention.

FIG. 4 illustrates a conceptual diagram of a projected user interface display and a FOV of a camera including an interaction zone in accordance with an embodiment of this invention.

FIG. 5 illustrates a projected user interface display with markers in accordance with an embodiment of this invention.

FIG. 6 illustrates an image of a projected user interface display and a user finger interacting with an object in the display captured with a visible light image capture device in accordance with an embodiment of the invention.

FIG. 7 illustrates an image of a projected user interface display and a user finger interacting with an object in the display captured with an InfaRed (IR) image capture device in accordance with an embodiment of the invention.

FIG. 8 illustrates a conventional RGB Bayer pattern for pixels in an image capture device in accordance with an embodiment of this invention.

FIG. 9 illustrates an R-G-B-IR pattern for pixels in an image capture device in accordance with an embodiment of this invention.

FIG. 10 illustrates a flow diagram of a process for detecting gesture interactions with objects in a projected user interface display in accordance with an embodiment of this invention.

FIG. 11 illustrates a flow diagram of a process for registering a projected user interface display with a FOV of one or more image capture devices in accordance with an embodiment of this invention.

FIG. 12 illustrates a flow diagram of a process for determining a geometric relationship between a projected user interface display on a projection surface and the FOV of a camera in accordance with an embodiment of the invention.

FIG. 13 illustrates a flow diagram of a process for determining 3D location information for a projection surface in accordance with an embodiment of the invention.

### DETAILED DISCLOSURE OF THE INVENTION

Turning now to the drawings, interaction systems for a projected user interface display in accordance with embodiments of the invention are illustrated. For purposes of this discussion, the terms 3D user interface, 3D gesture based user interface, and Natural User Interface (NUI) are used interchangeably through this description to describe a system that captures images of a user and determines when certain 3D gestures are made that indicate specific interactions with a projected user interface. The present disclosure describes a 3D user interface system that senses the position of an interaction medium; correlates the position information to the display context; and provides the information to interactive applications for use in interacting with interactive objects in the display.

In accordance with some embodiments, the system includes a processing system that generates a user interface display for a 3D user interface. For purposes of this discussion, a 3D user interface is an interface that includes interactive objects that may be manipulated via 3D gestures and a user interface display is the visual presentation of the interface with the interactive objects arranged in a particular manner to facilitated interaction via gestures. A projector connected to the processing system can project a user interface display onto a projection surface. A user can use an interaction medium to interact with interactive objects in the user interface display. For purposes of this discussion, an interaction medium may include a hand, finger(s), any other body part(s), and/or an arbitrary object, such as a stylus. A machine vision system including least one camera can be utilized to capture images of a projected display and/or the interaction medium in accordance with some embodiments of this invention. In a number of embodiments, at least one camera captures images that include visible light data and Infrared (IR) image data. For purposes of this discussion, visible light image data is data for one of more colors visible light in the image and can be captured by at least one of red, green and blue pixels. Although in other embodiments, any color model appropriate to the requirements of specific applications can be utilized including (but not limited to) a cyan, yellow, and magenta color model. In accordance with a number of embodiments, the at least one camera can capture images that include both visible light data and IR image data. In accordance with some embodiments, IR emitters may be used to project IR light onto the projection surface to illuminate the interaction medium in low light conditions for the camera.

In accordance with some embodiments of this invention, visible light image data from captured images can be used to register the projected 3D interface with the Field of View (FOV) of the at least one camera. In accordance with many embodiments, registration can include determining a geometric relationship between a projected user interface display on a display surface with the FOV(s) of the at least one camera. In accordance with a number of embodiments, the registration may include a determination of location information for the projection surface indicating a position of the projection surface in 3D space.

In accordance with some embodiments, the IR image data from the capture images is used to detect gestures of the interaction medium and/or location information for the interaction medium. Registration information can then be used to translate the information for the interaction medium to a position within the user interface display. The translated location and interaction gesture information can be provided to an interactive application for interacting with a selected interactive object in the user interface display.

3D gestured based interaction systems for a projected 3D user interface in accordance with various embodiments of the invention are described further below.

### Real-Time Gesture Based Interactive Systems for Projected User Interface Displays

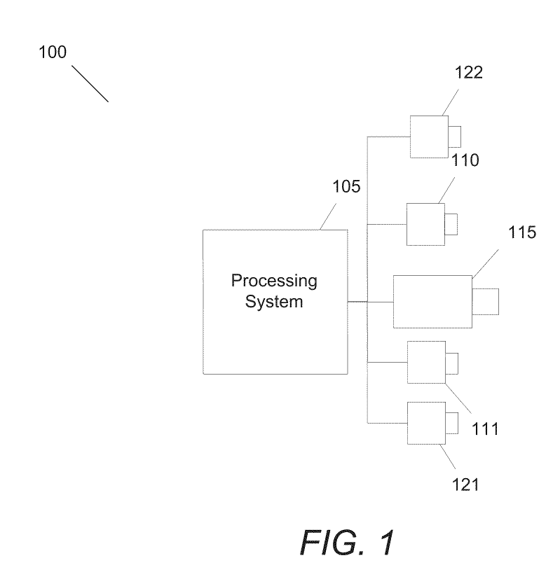

A projected 3D interface system in accordance with an embodiment of the invention is illustrated in FIG. 1. The projected 3D interface system 100 includes a processing system 105 configured to provide a 3D interface display to project to projector 115 and to receive image data captured by at least one camera 110-111. The projector 115 projects a user interface display onto a projection surface. In accordance with some embodiments, the projector uses Light Emitting Diodes (LEDs) to project the user interface display. In other embodiments, any of a variety of projection technologies appropriate to the requirements of specific applications can be utilized. The use of LEDs for projection is typically characterized by only the projection of light in the visible spectrum. At least one camera 110-111 is configured to capture images that include the display projected by projector 115. In accordance with some embodiments, the at least one camera 110-111 substantially co-located with the projector 115. In accordance with a number of embodiments of this invention, co-located means that the at least one camera 110-111 and projector 115 are situated with respect to one another such that the Field of View (FOV) of each of the at least one camera 110-110 substantially covers the field of projection of projector 115 at a predetermined minimum and/or maximum distance from the projection surface. In accordance with many embodiments, at least one of the one or more cameras is configured to capture IR image data. In a number of embodiments, one or more particular cameras capture IR images. In several other embodiments, each camera may include IR pixels and conventional Red, Green, and Blue pixels to capture both IR data and visible light data for an image. In certain embodiments, the at least one camera including IR pixels operates in an ambient light environment. In accordance with many embodiments, one or more IR emitters 120-121 are provided to emit IR to illuminate the area to allow the system to operate in low light conditions by increasing the intensity of IR radiation incident on the pixels of the at least one camera 110-111. In accordance with some embodiments, at least one IR emitter 120-121 is co-located with each IR sensing camera. In accordance with a number of embodiments, the IR emitters are co-positioned with the projector 115 and/or incorporated into the projector.

Although a specific real-time gesture based interactive system including two cameras is illustrated in FIG. 1, any of a variety of real-time gesture based interactive systems configured to capture image data from at least one view can be utilized as appropriate to the requirements of specific applications in accordance with embodiments of the invention. Processing systems in accordance with various embodiments of the invention are discussed further below.

### Processing System

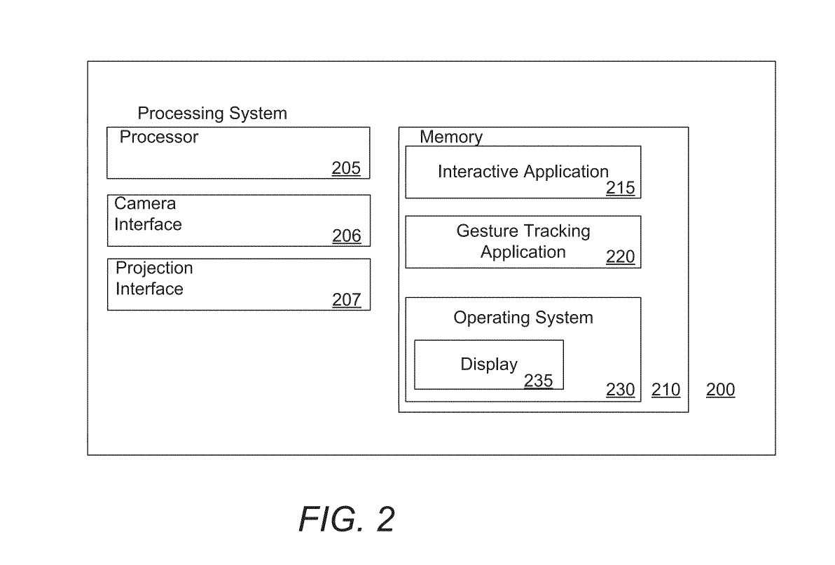

Processing systems in accordance with many embodiments of the invention can be implemented using a variety of software configurable computing devices including (but not limited to) personal computers, tablet computers, smart phones, embedded devices, Internet devices, wearable devices, and consumer electronics devices such as (but not limited to) televisions, projectors, disc players, set top boxes, glasses, watches, and game consoles that have an integrated projector or are attached to an external projector. A processing system in accordance with an embodiment of the invention is illustrated in FIG. 2. The processing system 200 includes a processor 205 that is configured to communicate with a camera interface 206, and a projector interface 207.

The processing system 120 also includes memory 210 which can take the form of one or more different types of storage including semiconductor and/or disk based storage. In accordance with the illustrated embodiment, the processor 205 is configured using an operating system 230. In some embodiments, the image processing system is part of an embedded system and may not utilize an operating system 230. Referring back to FIG. 2, the memory 210 also includes a 3D gesture tracking application 220 and an interactive application 215.

The 3D gesture tracking application 220 processes image data received via the camera interface 206 to identify 3D gestures such as hand gestures including initialization gestures and/or the orientation and distance of individual fingers. These 3D gestures can be processed by the processor 205, which can detect an initialization gesture and initiate an initialization process that can involve defining a 3D interaction zone in which a user can provide 3D gesture input to the processing system. Following the completion of the initialization process, the processor can commence tracking 3D gestures that enable the user to interact with a projected user interface display generated by the operating system 230 and/or the interactive application 225.

In accordance with many embodiments, the interactive application 215 and the operating system 230 configure the processor 205 to generate and render an initial user interface using a set of interface objects. The interface objects can be modified in response to a detected interaction with a targeted interface object and an updated user interface rendered. Targeting and interaction with interface objects can be performed via a 3D gesture based input modality using the 3D gesture tracking application 220. In accordance with several embodiments, the 3D gesture tracking application 220 and the operating system 230 configure the processor 205 to capture image data using an image capture system via the camera interface 206, and detect a targeting 3D gesture in the captured image data that identifies a targeted interface object within a projected user interface display. The processor 205 can also be configured to then detect a 3D gesture in captured image data that identifies a specific interaction with the targeted interface object. Based upon the detected 3D gesture, the 3D gesture tracking application 220 and/or the operating system 230 can then provide an event corresponding to the appropriate interaction with the targeted interface objects to the interactive application 220 to enable the interactive application 220 to update the projected user interface display in an appropriate manner. Although specific techniques for configuring a processing system using an operating system, a 3D gesture tracking application, and an interactive application are described above with reference to FIG. 2, any of a variety of processes can be performed by similar applications and/or by the operating system in different combinations as appropriate to the requirements of specific processing systems in accordance with embodiments of the invention.

In accordance with many embodiments, the processor 205 receives frames of video via the camera interface 206 from at least one camera or other type of image capture device. The camera interface can be any of a variety of interfaces appropriate to the requirements of a specific application including (but not limited to) the USB 2.0 or 3.0 interface standards specified by USB-IF, Inc. of Beaverton, Oreg., and the MIPI-CSI2 interface specified by the MIPI Alliance. In accordance with a number of embodiments, the received frames of video include image data represented using the RGB color model represented as intensity values in three color channels and/or IR image represented as intensity values in the IR channel. In accordance with several embodiments, the received frames of video data include monochrome image data represented using intensity values in a single color channel. In accordance with several embodiments, the image data represents visible light. In accordance with other embodiments, the image data represents intensity of light in non-visible portions of the spectrum including (but not limited to) the infrared, near-infrared, and ultraviolet portions of the spectrum. In certain embodiments, the image data can be generated based upon electrical signals derived from other sources including but not limited to ultrasound signals. In several embodiments, the received frames of video are compressed using the Motion JPEG video format (ISO/IEC JTC1/SC29/WG10) specified by the Joint Photographic Experts Group. In a number of embodiments, the frames of video data are encoded using a block based video encoding scheme such as (but not limited to) the H.264/MPEG-4 Part 10 (Advanced Video Coding) standard jointly developed by the ITU-T Video Coding Experts Group (VCEG) together with the ISO/IEC JTC1 Motion Picture Experts Group. In certain embodiments, the processing system receives RAW image data. In several embodiments, the camera systems that capture the image data also include the capability to capture dense depth maps and the image processing system is configured to utilize the dense depth maps in processing the image data received from the at least one camera system. In several embodiments, the camera systems include 3D sensors that capture dense depth maps including (but not limited to) a time-of-flight camera and/or depth cameras.

In accordance with many embodiments, the projection interface 250 is utilized to drive a projector device that can be integrated within the processing system and/or external to the processing system. In a number of embodiments, the HDMI High Definition Multimedia Interface specified by HDMI Licensing, LLC of Sunnyvale, Calif. is utilized to interface with the projection device. In other embodiments, any of a variety of display interfaces appropriate to the requirements of a specific application can be utilized.

Although a specific image processing system is illustrated in FIG. 2, any of a variety of processing system architectures is capable of gathering information for performing real-time hand tracking and updating a projected user interface display in response to detected 3D gestures in accordance with embodiments of the invention. Projected Displays and Captured Images

In accordance with many embodiments of this invention, a user interface is projected onto a surface by a projector and images of the display and a gesturing object, such as a finger and/or hand, are captured and processed to determine interactions with interactive objects in the display. In order to determine interaction with particular interactive objects in the display, images of the display can be captured to determine the relationship between the projected display and FOV of the camera.

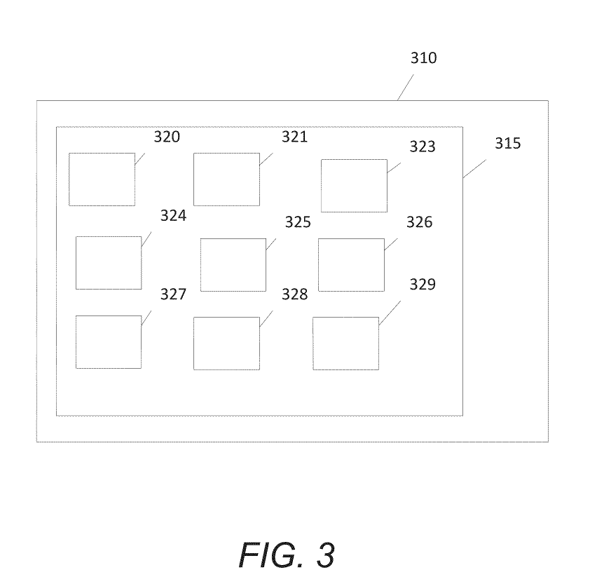

A conceptual view of a display projected by a projector and the FOV of a camera in accordance with an embodiment of this invention is shown in FIG. 3. In FIG. 3, display 315 is projected by a projector onto a surface that is an unknown distance from the projector. The display 315 includes interactive objects 320-329. The interactive objects are objects that may be manipulated in some way using 3D gestures. FOV 310 is the FOV of the camera at the plane of the projection surface. One skilled in the art will note that the FOV is shown as substantially rectangular in FIG. 3. However, the FOV may be substantially trapezoidal, circular, ovular or any other shape as determined by the optics, physical characteristics, and geometrical characteristics of the camera. In FIG. 3, display 315 is offset to one side of the FOV 310 due to the spacing between the projector and the at least one cameras. One skilled in the art will note that actual offset may not be as acute as shown in FIG. 3. Further, the exact offset will depend upon the spacing between the camera and the projector and/or the distance from the projection surface to each of the camera and the projector.

Various embodiments of the invention may use one of two modes for interacting with interactive object in the user interface display. In accordance with some embodiments, the first mode of interacting is projection surface interactions in which the gestures for selecting and interacting with an interactive element of the display may be performed on the display surface to simulate a touchpad. In accordance with some embodiments, a two phase gesture model may be used in which a first gesture is made to select an interactive object and a second gesture is made to interact with the selected object. These gestures are made with an interaction zone in 3D space and may not interact with the projection surface. For example, the user may point at a selected object in the interaction zone to select the object and make a tapping gesture (extending and contracting the finger) to interact with the object.

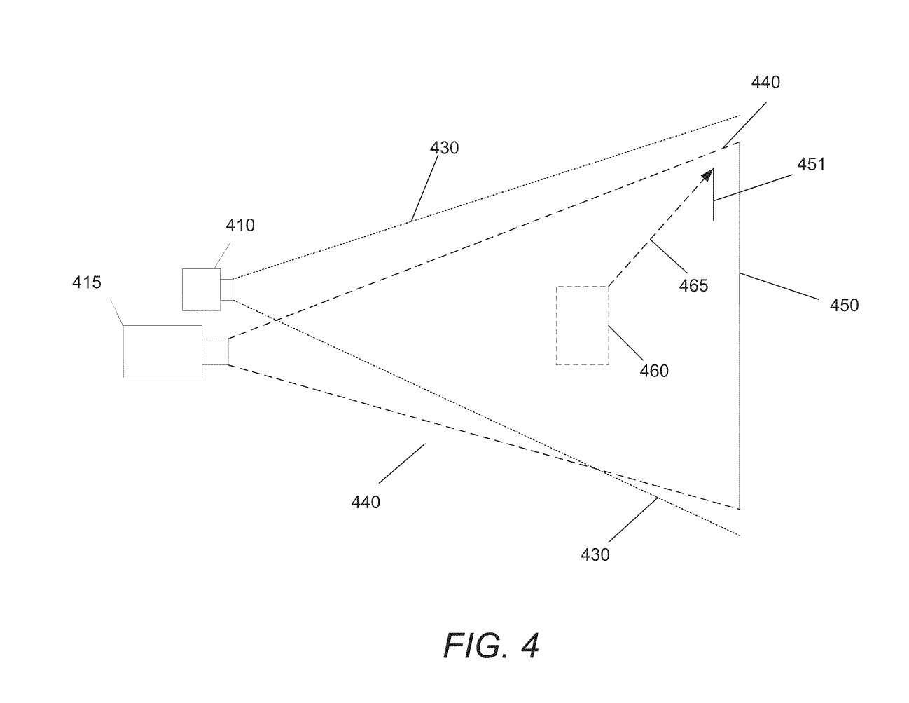

In accordance with embodiments that use a two phase gesture model an interaction zone of detecting interactions may be defined. A side view of the FOV and display in a system that supports 3D gesture based interactions with a projected user interface in accordance with an embodiment of this invention is shown in FIG. 4. In FIG. 4, projector 415 is projecting display 450 onto a projection surface with a FOV 440. Camera 410 has a FOV 430 that substantially encompasses FOV 440. A 3D interaction zone 460 is defined within the FOV 440 of the camera and the FOV 450 of the projector. Gestures made in the 3D interaction zone 460 are analyzed to determine a point of interest 465 in display 450.

In accordance with certain embodiments, a 3D interaction zone is defined in 3D space and motion of a finger and/or gestures within a plane in the 3D interaction zone substantially parallel to the plane of the projected display can be utilized to determine the location on which to overlay a target on the projected display.

A feature of systems in accordance with many embodiments of the invention is that they can utilize a comparatively small interaction zone. In accordance with several embodiments, the interaction zone is a predetermined 2D or 3D space defined relative to a tracked hand such that a user can traverse the entire 2D or 3D space using only movement of the user's finger and or wrist. Utilizing a small interaction zone can enable a user to move a target from one side of a display to another in an ergonomic manner. Larger movements, such as arm movements, can lead to fatigue during interaction of even small duration. In several embodiments, the size of the interaction zone is determined based upon the distance of the tracked hand from a reference camera and the relative position of the tracked hand in the field of view. In addition, constraining a gesture based interactive session to a small interaction zone can reduce the overall computational load associated with tracking the human hand during the gesture based interactive session.

When an initialization gesture is detected, a 3D interaction zone can be defined based upon the motion of the tracked hand. In several embodiments, the interaction zone is defined relative to the mean position of the tracked hand during the initialization gesture. In a number of embodiments, the interaction zone is defined relative to the position occupied by the tracked hand at the end of the initialization gesture and/or can follow the tracked hand following initialization. In certain embodiments, the interaction zone is a predetermined size. In many embodiments, the interaction zone is a predetermined size determined based upon human physiology. In several embodiments, a 3D interaction zone corresponds to a 3D space that is no greater than 160 mm×90 mm×200 mm. In certain embodiments, the size of the 3D interaction zone is determined based upon the scale of at least one of the plurality of templates that matches a part of a human hand visible in a sequence of frames of video data captured during detection of an initialization gesture and the distance of the part of the human hand visible in the sequence of frames of video data from the camera used to capture the sequence of frames of video data. In a number of embodiments, the size of a 3D interaction zone is determined based upon the region in 3D space in which motion of the human hand is observed during the initialization gesture. In many embodiments, the size of the interaction zone is determined based upon a 2D region within a sequence of frames of video data in which motion of the part of a human hand is observed during the initialization gesture. In systems that utilize multiple cameras and that define a 3D interaction zone, the interaction zone can be mapped to a 2D region in the field of view of each camera. During subsequent hand tracking, the images captured by each camera can be cropped to the interaction zone to reduce the number of pixels processed during the gesture based interactive session. Although specific techniques are discussed above for defining interaction zones based upon hand gestures that do not involve gross arm movement (i.e. primarily involve movement of the wrist and finger without movement of the elbow or shoulder), any of a variety of processes can be utilized for defining interaction zones and utilizing the interaction zones in conducting 3D gesture based interactive sessions as appropriate to the requirements of specific applications in accordance with embodiments of the invention.

Referring back to FIG. 4, gestures made in the interaction zone 460 are analyzed to determine a point of interest 465 in display 450. In the shown embodiment, the point of interest 465 corresponds to interactive object 451 in display 450. Processes for detecting a gesture and determining a point of interest in a display in accordance with embodiments of this invention are described below.

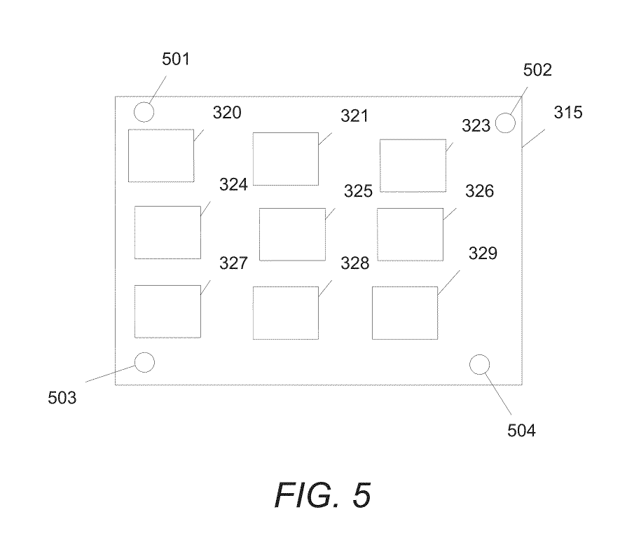

Regardless of the mode of interaction, a geometric relationship the projected user interface display and the FOV of the camera may need to be determined for use in determining the particular portion of the display that the gestures are targeting for interaction. In accordance with some embodiments, a projected display may include Augmented Reality (AR) tags or some other registration icon for use in establishing a geometric relationship between the projected display and the FOV of a camera. A display including AR tags in accordance with an embodiment of this invention is shown in FIG. 5. Display 315 includes interactive objects 320-328 and AR tags 501-504 in accordance with the illustrated embodiment. However, the display 315 may include any number of AR tags depending on the processes use to establish the geometric relationship between the FOV of the camera and display. Furthermore, interactive objects that are at a known position in the user interface display may be used as AR tags in some embodiments. In accordance with the shown embodiment, four AR tags 501-504 are used to provide 8 equations (2 equations/tag) to solve the homography that includes 7 unknowns. Further, AR tags 501-504 are shown in the corners of display 215. However, the AR tags may be placed at any location in the display without departing from embodiments of the invention. Processes for defining a geometric relationship between the display and the FOV of a camera in accordance with embodiments of the invention are discussed in further detail below.

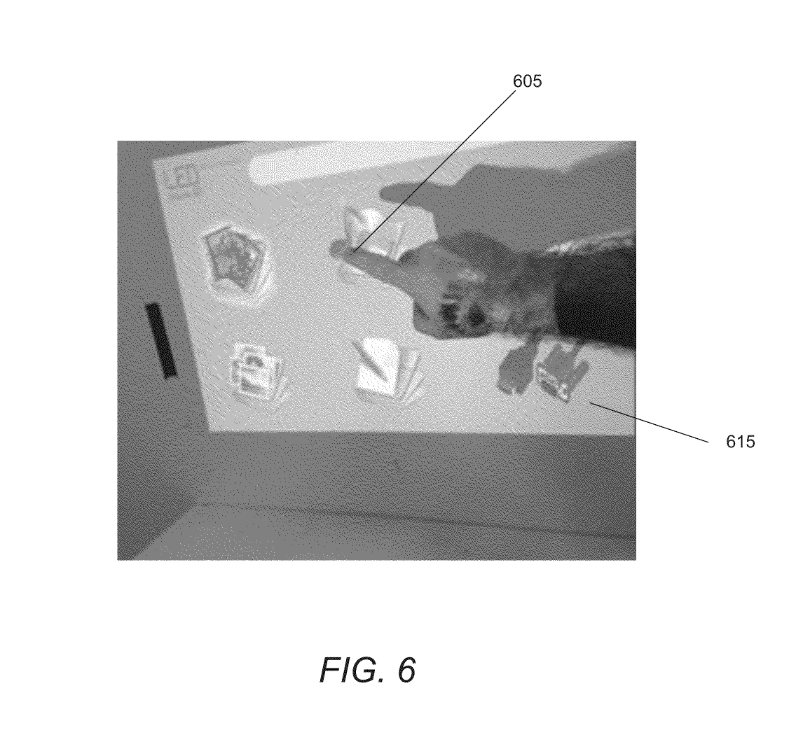

One problem to detecting gestures for interacting with a projected user interface display in accordance with many embodiments of this invention is that the projected display is also projected upon to an interaction medium such as a hand and/or finger that is interacting with interactive objects in the display. An example of a projected 3D user display being projected onto an interaction medium in accordance with an embodiment of the invention is shown in FIG. 6. In FIG. 6, display 615 is being projected onto a projection surface and a hand and finger 605 of a user, acting as an interactive medium, is interacting with objects in the display. As can be seen in FIG. 6, the finger 605 is pointing at an object within a user interface display 615 and as the finger is pointing to the object with the display, the surrounding display is projected onto the hand. As such, finger 605 and the associated hand are the same color as the display making standard computer vision algorithms, particularly those heavily relying on color clues, for detecting the finger 605 in an image more complex if not unfeasible to perform.

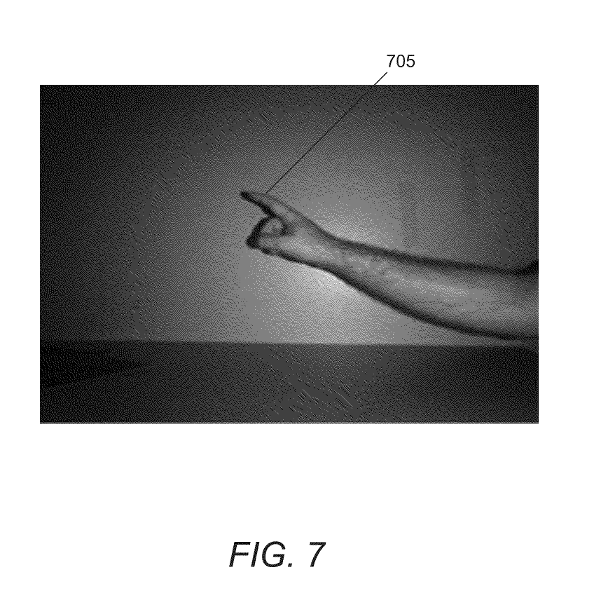

To distinguish the finger or other interactive medium from the projected user interface display, an IR image and/or IR information from captured images may be used to identify the interaction medium. An example of the IR data for an image of a display projected over a hand in accordance with an embodiment of this invention is shown in FIG. 7. As can be seen in FIG. 7, an IR image or the IR data from an image of the display being projected over a finger 705 only includes the finger 705 as well as the attached hand and arm. The image does not include the projected display which is projected using only visible light.

### Pixel Arrangement in the at Least One Cameras

In accordance with several embodiments of the invention, at least one camera of the processing system is able to capture IR data for the image to use for gesture detection. In some embodiments, one or more of the at least one cameras are IR cameras. In accordance with some embodiments, one or more of the cameras are configured to sample visible light and at least a portion of the IR spectrum to obtain an image. The IR data of the image can then used for gesture detection. A pixel configuration of a camera that captures only visible light is shown in FIG. 8. In FIG. 8, pixel array 805 has red, green, and blue pixels configured in a Bayer pattern. This allows the pixel array 805 to capture an image by sampling incident light in the visible portion of the spectrum.

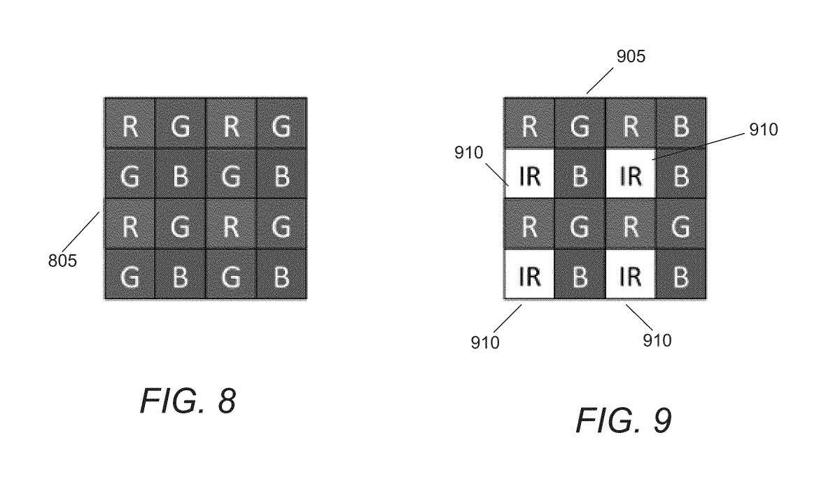

A pixel configuration of a camera that captures both visible light data and IR data in accordance with an embodiment of the invention is shown in FIG. 9. In the pixel array 905, IR pixels 910 replace half the green pixels in the Bayer pattern. However, other schemes may be used in other embodiments. The IR pixels capture IR data for the image; and the red, green, and blue pixels capture visible light information. The capture of IR data and visible light data in one image allows the data from the one image to be used to both register the display with the FOV of the camera and to perform gesture detection in accordance with some embodiments of this invention. One skilled in the art will recognize that a particular arrangement of IR, R, G, and B pixels is shown in FIG. 9. However, other arrangements of IR, R, G, and B pixels may be used without departing from embodiments of this invention. Furthermore, any of a variety of color filters can be utilized to image different portions of the visible and IR spectrum including cameras that include white pixels that sample the entire visible spectrum. For example, a camera may include a pixel array that includes two types of pixels that are interlaced with one another in accordance with some embodiments. The first type of pixel captures a small set of wavelengths (such as IR) centered at the wavelength of an emitter. The second set of pixels captures a portion or all of the visible light portions of the spectrum and/or other spectrum ranges excluding those captured by the first set of pixels.

Process for Providing Gesture Interaction with Projected User Interface Display

In accordance with many embodiments of this invention, a user may interact with interactive objects in a user interface display using gestures. In accordance with some embodiments, the gestures include surface interaction gestures where the user interacts with the projected display on the display surface. In many embodiments, the surface interaction gestures simulate a touchpad interaction with a touch sensitive display. In accordance with some embodiments, the user performs 3D gestures a distance above the display surface (i.e. not contacting the display surface) in a 3D interaction zone where only gestures made in the 3D interaction zone are recognized. In accordance with many embodiments, a 3D interaction zone system is a two phase process including a targeting gesture that then enables interaction gestures for interacting with the targeted interactive object. The processes performed in accordance with some embodiments of this invention may be used to provide a surface interaction and/or a 3D interaction zone system for providing gestures.

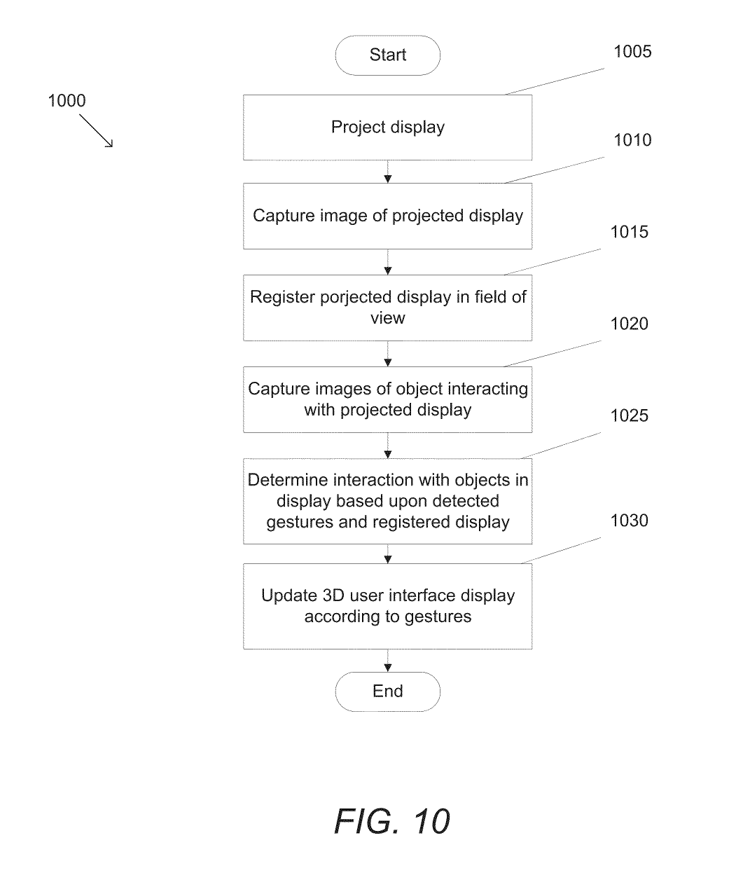

A process for providing gesture interaction with a projected user interface display in accordance with embodiments of this invention is shown in FIG. 10. In process 1000, the user interface display is projected onto a projection surface by the projector (1005), the at least one cameras capture an image of the projected display (1010), the projected display is registered to the FOV of the at least one cameras images of an interaction medium (1015), images of the interaction medium interacting with the display are captured by the at least one camera (1020), interactions with interactive objects in the user interface display are determined based upon identified gestures of the interaction medium in the captured images (1025), and the display is updated accordingly (1030).

In accordance with some embodiments, the registration (1015) of the projected user interface display to the field of the view of the camera is performed periodically. In accordance with many embodiments, the registration of the display to the FOV of the cameras may be set based upon the distance between the camera and projector being set and the projection distance being fixed. In accordance with a number of embodiments, the registration may be performed based upon color image data from one or more images used for gesture detection. Various processes for performing registration of the displayed user interface display to the FOV of a camera are described provided below.

In accordance with some embodiments, the at least one camera captures IR images of the interaction medium to perform gesture detection (1020. In accordance with many embodiments, the at least one camera captures images of the interaction medium that include IR image data and visible light image data. In accordance with a number of embodiments, the visible light data from an image is used to register the projected user interface display with the FOV of a camera and the IR data is used to perform gesture detection.

In accordance with some embodiments, the interactions are determined using a surface interaction mode. In some other embodiments, the interactions are determined using a two gesture mode based upon gestures detected in an interaction zone. In a number of embodiments, the interactions are detected using depth information derived from the image data. In accordance with several embodiments, the depth information is derived from image information captured by depth cameras.

Although a process for providing a 3D gesture interaction system for a projected user interface display in accordance with an embodiment of this invention is discussed above with respect to FIG. 10, other processes may be used to perform registration in other embodiments of this invention.

Process for Registering User Interface Display with FOV of a Camera

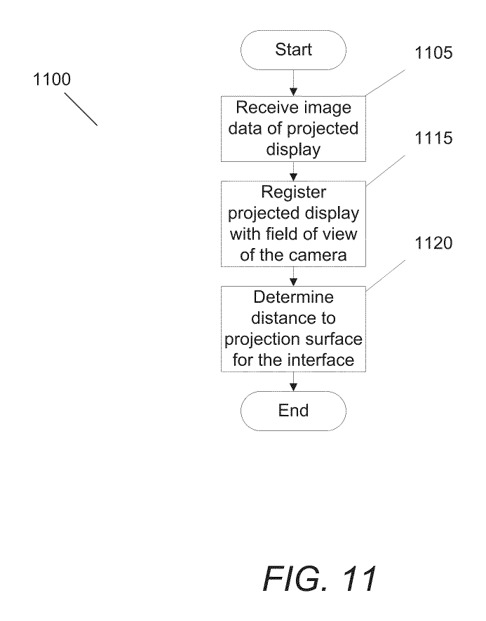

As discussed above with reference to FIG. 3 the FOV of the at least one camera and the projected user interface display may not be aligned. As such, the user interface display is registered with the FOV of a camera to enable a processing system to determine which particular interactive object in the display is the target of a detected gesture based interaction. For purposes of this discussion, registration means that a process is performed to establish a geometric relationship between the display and the FOV of the camera. This is used to translate the position of certain gestures or objects of the interaction medium in an image to a position within the display. This position may then be provided to interaction applications to provide interaction information to the selected interactive object for use in performing the desired interaction. A process for registering a projected display to the FOV of at least one camera in accordance with an embodiment of this invention is shown in FIG. 11.

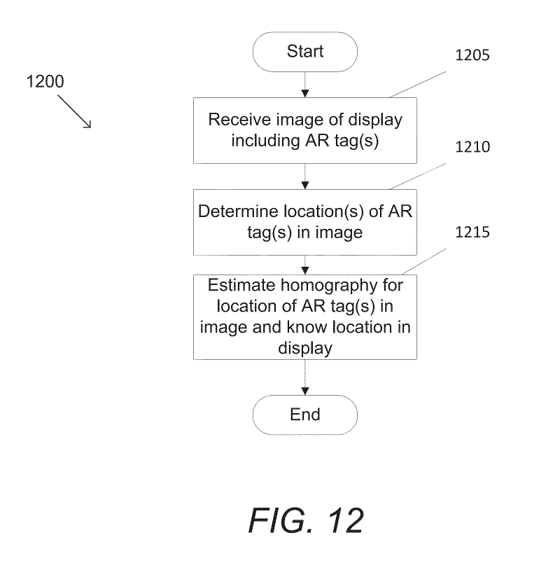

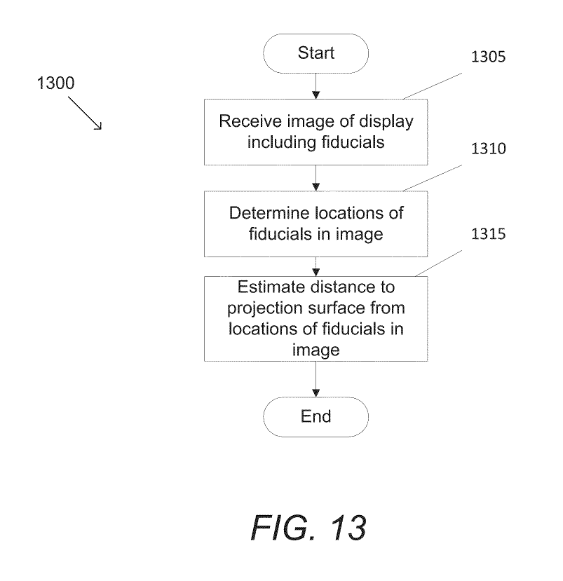

In process 1100, the processing system receives the image data for an image of the projected display (1105), determines a geometric relationship between the projected user interface display and the FOV of the camera (1115) and determines 3D location inform for the projection surface of the projected 3D user interface (1120). In accordance with some embodiments, the process of registering the display and the FOV of at least one camera is performed prior to gesture detection using images that include only the projected display. In accordance with many embodiments, the registration is periodically performed. In accordance with a number of embodiments, the registration process is performed for every Nth image captured during gesture detection. Furthermore, an image only including visible light data for the image is used in accordance with some embodiments. In accordance with many embodiments, the image data used for registration includes both visible light image data and IR image data; and the visible light image data from the image is used for registration. In several embodiments, the IR image data is utilized to identify portions from the visible light data to ignore due to the presence of an occluding object between the projector and the projection surface. Various processes for determining the geometric relationship in accordance with an embodiment of this invention is discussed below with respect to FIG. 12 and a process for determining the location of the projection surface is discussed below with respect to FIG. 13.

It is given that the projected display and a captured image are related by a homography having seven (7) unknowns when the projection surface is substantially planar. Furthermore, the projector and the at least one camera are aligned such the projected and captured image may be coplanar in accordance with some embodiments of this invention. Thus, the geometric relationship between the projection plane and the FOV of the camera can be simplified to a similarity transform. The projector and the at least one camera may be mounted in parallel in accordance with some embodiments. The parallel mounting means that only a 2D translation of points and scale in the projected display need to be estimated resulting in 3 unknowns. These transformations may be represented in a 3×3 matrix, H, such that mapping from the captured image to the projected display is performed via a matrix multiplication as follows:

[symbol]

=h( [symbol] )=H·

[symbol]

where [symbol] is pixel coordinates in an image captured by the at least one camera and [symbol] are pixel coordinates of the display which may respectively be represented as

[symbol]

=k·(u_{cam}v_{cam}1)^{T}

[symbol]

=(u_{dis}v_{dis}1)^{T}

For a homography, H is a general 3×3 matrix, whereas for the of a similarity transform the matrix takes the following constrained form:

$$H = {\underbrace{[ \begin{matrix}cos θ & - sin θ & 0 \\ sin θ & cos θ & 0 \\ 0 & 0 & 1\end{matrix} ]}}_{R} \cdot ( \begin{matrix}s & 0 & {t}_{u} \\ 0 & s & {t}_{v} \\ 0 & 0 & 1\end{matrix} )$$

Where R is the rotational matrix, s is the scale of change; tᵤ and tᵥ are the translation in units of pixels and θ is the angle of the 2D rotation. When the projector and the at least one camera are mounted in parallel the rotation matrix, R, becomes the identity matrix. Furthermore, the matrix, H, is invertible such that after H is determined, H may be applied to position from the captured image to determine a corresponding location on the display with little computational overhead in the following manner:

[symbol]

=H⁻¹·

[symbol]

In accordance with some embodiments of this invention, the homography between the projected user interface display and the FOV of the camera is determined using AR tags included in the display as discussed above with reference to FIG. 5 to register the projected user interface display (1115). In accordance with many embodiments, the homography is determined using an exhaustive template matching search wherein one template per scale and orientation is included and a similarity metric is determined for each pixel with the template with the most similarity over all of the pixels providing the rotational, scale and transitional parameter.

A process for determining the homography using AR tags is shown in FIG. 12. In process 1200, color image data for an image of the display including the four AR tags is obtained (1205). In accordance with the shown embodiment, the projected display includes four AR tags because the homography has seven (7) unknowns and each AR tag provides two equations. In accordance with some embodiments, the visible light image data is from an image captured using a color (RGB) camera. In accordance with some embodiments, the visible light data is image data from a captured image that includes both data for at least one color in the visible light spectrum and IR image data for the image. The locations of each AR tag in the image are determined (1210). In accordance with some embodiments, a computer vision technique is used to determine the locations of the AR tags. Examples of computer vision techniques include, but are not limited to, template matching and descriptor matching. After the positions of the AR tags are determined, the known locations of the AR tags in the display and the determined locations in the captured image are used to provide a set of linear equations. The linear equations are then solved using any of a variety of techniques including, but not limited to, simple least squares, total least squares, least median of squares, and/or RANSAC.

Although a process for determining a geometric relationship between the projected image and the FOV of the at least one camera in accordance with embodiments of this invention are discussed with reference to FIG. 12, one skilled in the art will recognize that other methods for determining a geometric relationship between the projected user interface display and the FOV of at least one camera may be used without departing from this invention.

### Determining 3D Location Information for a Projection Surface

Referring back to FIG. 11, the determination of 3D location information for the projection surface (1120) in performed in the following manner. The location of the projection surface in 3D may be determined for use in determining whether an interaction occurs in embodiments using projection surface interaction mode. For example, a user may select an object by touching the object on the projection surface and/or by placing the interaction medium within a predefined proximity of the surface. The 3D location information for the projection surface may be determined using the visible light image data from the captured images in some embodiments. In some embodiments, the visible light data from images that only include the projected surface is used to determine the 3D location information for the projected surface. In some embodiments, the visible light data used determine the 3D location information for the projected surface is from captured images that include both the projected 3D user interface and a interaction medium. In many embodiments, the 3D location information for the projection surface may be determined based upon the visible light image data from captured images that include both visible data and IR data for the image.

Although a process for registering a projected 3D user interface with at least one camera in accordance with an embodiment of this invention is discussed above with respect to FIG. 11, other processes may be used to perform registration in other embodiments of this invention.

A process for determining the 3D location information for the projection surface in accordance with an embodiment of this invention is shown in FIG. 13. Process 1300 includes receiving the visible light image data of a captured image including the projected user interface display that includes fiducials (1305), determining the locations of the fiducials in the image (1310), and estimating the location of the projection surface in 3D space based on the locations of the fiducials. In accordance with some embodiments, the fiducials are at least three AR tags such as the AR tags discussed with reference to FIG. 5. In accordance with some embodiments, the fiducials are interactive objects at known location in the user interface display. In a number of embodiments, the fiducials are other markers added into the user interface display.

In some embodiments, a triangulation technique is used to determine the 3D position of the fiducials in some embodiments based upon the internal characteristics of the cameras (and the projector) being known and the offsets of the camera(s) and projector from one another being known and the positions of the fiducials in the UI are known. Thus, the focal length, f, and the baseline (distance between the camera and the camera), b, are known. Further the locations of the fiducials are represented as [u₁,v₁]^{T} for the first camera and [u₂=u₁−d,v₂=v₁]^{T} where d is the disparity between cameras. As such the 3D coordinates of a fiducial with respect to the stereo reference system may be obtained by the following equation:

$$[ \begin{matrix}x \\ y \\ z\end{matrix} ] = [ \begin{matrix}1 / f & 0 & \frac{- {c}_{x}}{f} \\ 0 & 1 / f & \frac{- {c}_{y}}{f} \\ 0 & 0 & 1\end{matrix} ] [ \begin{matrix}u \\ v \\ 1\end{matrix} ] * \frac{bf}{d}$$

where [cₓ, c_{y}]^{T} is the optical center in pixel coordinates and f is the focal length in pixel coordinates for each of the two cameras. Once the coordinates for the three fiducials are known ([x₃, y₃, z₃]^{T}, [x₃, y₃, z₃]^{T}, [x₃, y₃, z₃]^{T}), the 3D location in space of the plane of the projection surface on which the 3D user interface is projected is determined by resolving the following equations:

$$\{ \begin{matrix}{ax}_{1} + {by}_{1} + {cz}_{1} + d = 0 \\ {ax}_{2} + {by}_{2} + {cz}_{2} + d = 0 \\ {ax}_{3} + {by}_{3} + {cz}_{3} + d = 0\end{matrix}$$

Although a process for determining the 3D location information for a projection surface in accordance with an embodiment of this invention is discussed above with respect to FIG. 13, other processes may be used to perform registration in other embodiments of this invention.

Processes for Gesture Detection and Interaction with Interactive Objects in the Projected Display

In accordance with some embodiments, the position of an interaction medium within an interaction zone is determined and used to control an object such as a cursor on a screen. In accordance with some embodiments of the invention, the interaction medium is a finger. Any number of techniques may be used to estimate the finger position in the interaction zone. Methods for estimating the position of a finger in an interaction zone in accordance with some embodiments of this invention are discussed in U.S. Pat. No. 8,655,021 issued to Dal Mutto et al. the relevant disclosure of which is incorporated by reference as if set forth herewith. The position information for the interaction medium is then used to determine a corresponding position on the projected user interface display and is provided to the interactive application for use in interacting with interactive objects on the screen. In accordance with some embodiments, position information may be used to control a cursor in the display. In many embodiments, the position of the interaction medium may be used to identify objects that are a point of interest and change the presentation of the points of interest in the display. In accordance with further embodiments the position of the interaction medium during a first, targeting gesture indicates a particular interactive object in the projected user interface display that user is targeting for interaction that is determined using the geometric relationship information generated during registration, and a second gesture with an interaction zone indicates a particular interaction with the targeted interaction object.

In accordance with a number of embodiments, the interaction medium and/or the shadow of the interaction medium may be used to determine a time and a location of a touch on the projected user interface display. In accordance with some of these embodiments, the time of touch is determined based upon substantial elimination of the shadow of the interaction medium in a captured image. In accordance with other embodiments, the time of touch may be determined using the 3D location information of the projected surface determined during the registration of the projected user interface display on the projection surface with the FOV of the at least one camera. In accordance with some of these embodiments, the location of the interaction within the projected display is determined by mapping the location of the interactive medium to the display based upon the geometric relationship information generated during registration of the projected display to the FOV of the camera.

In accordance with some embodiments, the interactions simulate touch interactions. As such, only interactions made substantially on the projection surface and/or within a predefined distance from the projection surface as determined based upon the calculated 3D location information of the projection surface may be detected. Examples of simulated touch interactions include, but are not limited to, a tap, touch tracking, double taps, touch gestures, and/or pinch to zoom interactions.

Although certain specific features and aspects of an interaction system for a projected user interface display have been described herein, many additional modifications and variations may be apparent to those skilled in the art. For example, the features and aspects described herein may be implemented independently, cooperatively or alternatively without deviating from the spirit of the disclosure. It is therefore to be understood that gaming system may be practiced otherwise than as specifically described. Thus, the foregoing description of the embodiments of the interaction system should be considered in all respects as illustrative and not restrictive, the scope of the claims to be determined as supported by this disclosure and the claims' equivalents, rather than the foregoing description.

What is claimed is:

1. A processing system configured to conduct Three Dimensional (3D) gesture based interactive sessions for a projected user interface display comprising:
a memory containing an image processing application; and
a processor directed by the image processing application read from the memory to:
receive image data that includes visible light image data and Infrared (IR) image data,
obtain visible light image data from the image data,
generate registration information for a user interface display on a projected surface with a field of view of one or more image capture devices using the visible light image data,
obtain IR image data from the image data, and
generate gesture information for an interaction medium using the IR data, and
identify an interaction with an interactive object with the user interface display using the gesture information and the registration information.

2. The processing system of claim 1 wherein the generating of the registration information includes determining geometric relationship information that relates the FOV of the at least one camera to the user interface display on the projection surface.

3. The processing system of claim 2 wherein the geometric relationship is the homography between the FOV of the at least one camera and the user interface display on the projection surface.

4. The processing system of claim 3 wherein the geometric relationship information is determined based upon AR tags in the projected user interface display.

5. The processing system of claim 4 wherein the projected user interface display includes at least four AR tags.

6. The processing system of claim 4 wherein the AR tags are interactive objects in the user interface display.

7. The processing system of claim 1 wherein the generating of the registration information includes determining 3D location information for the projection surface indicating a position of the projection surface in 3D space.

8. The processing system of claim 7 wherein the 3D location information is determined based upon fiducials within the user interface display.

9. The processing system of claim 8 wherein the user interface display includes at least 3 fiducials.

10. The processing system of claim 3 wherein each fiducial in the user interface display is an interactive object in the user interface display.

11. The processing system of claim 1 wherein the interaction medium is illuminated with an IR illumination source.

12. The processing system of claim 1 wherein the visible light image data is obtained from images captured by the at least one camera that include only the projected user interface display on the projection surface.

13. The process system of claim 1 wherein the visible light image data is obtained from images captured by the at least one camera that include the interaction medium and the projected user interface display on the projection surface.

14. The processing system of claim 1 wherein the IR image data is obtained from images captured by the at least one camera that include the interaction medium and the projected user interface display on the projected surface.

15. The processing system of claim 1 wherein the image data is captured using at least one depth camera.

16. A method for providing a Three Dimensional (3D) gesture interactive sessions for a projected user interface display comprising:
generating a user interface display including interactive object using a processing system;
projecting the user interface display onto a projection surface using a projector;
capturing image data of the projected user interface display on the projection surface using at least one camera;
obtaining visible light image data from the image data using the processing system;
generating registration information for the user interface display on the projected surface with the field of view of one or more image capture devices providing the image data from the visible light data using the processing system;
obtaining the IR image data from the image data using the processing system; and
generating gesture information for an interaction medium in the image data from the IR image data using the processing system; and
identifying an interaction with an interactive object with the user interface display using the gesture information and the registration information.

17. The method of claim 16 wherein the generating of the registration information includes determining geometric relationship information that relates the FOV of the at least one camera to the user interface display on the projection surface using the processing system.

18. The method of claim 17 wherein the geometric relationship is the homography between the FOV of the at least one camera and the user interface display on the projection surface.

19. The method of claim 18 wherein the geometric relationship information is determined based upon AR tags in the projected user interface display.

20. The method of claim 19 wherein the projected user interface display includes at least four AR tags.

21. The method of claim 19 wherein the AR tags are interactive objects in the user interface display.

22. The method of claim 16 wherein the generating of the registration information includes determining 3D location information for the projection surface indicating a location of the projection surface in 3D space using the processing system.

23. The method of claim 22 wherein the 3D location information is determined based upon fiducials within the user interface display.

24. The method of claim 23 wherein the user interface display includes at least 3 fiducials.

25. The method of claim 23 wherein each fiducial in the user interface display is an interactive object in the user interface display.

26. The method of claim 16 further comprising:
emitting IR light towards the projected surface using at least one IR emitter to illuminate the interaction medium.

27. The method of claim 16 wherein the visible light image data is obtained from images captured by the at least one camera that include only the projected user interface display on the projection surface.

28. The method of claim 16 wherein the visible light image data is obtained from images captured by the at least one camera that include the interaction medium and the projected user interface display on the projection surface.

29. The method of claim 16 wherein the IR image data is obtained from images captured by the at least one camera that include the interaction medium and the projected user interface display on the projection surface.

30. The method of claim 16 wherein the image data is captured using at least one depth camera.
